(19) United States
(12) Patent Application Publication
(10) Pub. No.: US 2004/0178646 A1
(43) Pub. Date: Sep. 16, 2004

(54) Apparatus to assist in the collection of debris

(76) Inventors: Gerald M. Root, Brampton (CA); Robert W. Panasiuk, Mississauga (CA)

Correspondence Address: TAROLLI, SUNDHEIM, COVELL & TUMMINO L.L.P., SUITE 1111, 526 SUPERIOR AVENUE, CLEVELAND, OH, 44114-1400, US

(21) Appl. No.: 10/387,214

(22) Filed: Mar. 12, 2003

(51) Int. Cl. A01B 1/20

(52) U.S. Cl. 294/51

(57) ABSTRACT

An apparatus to assist in the collection of debris distributed over the ground. In one embodiment the apparatus comprises a hopper and a handle secured to the hopper. The hopper includes a bottom surface with at least one generally flat ground engaging portion. The hopper has a leading edge and a trailing edge. The handle is adapted to facilitate movement of the hopper along the surface area with the bottom surface of the hopper generally contacting the ground such that the leading edge of the hopper is forced into contact with debris distributed over the ground. The debris is then collected and directed into the hopper.

### FIELD OF THE INVENTION

This invention relates to an apparatus that may be used to help collect debris that is distributed over a relatively large area. In one particular embodiment, the invention relates to an apparatus that may be used to help collect leaves or similar debris that is strewn across a lawn or the surface of the ground.

### BACKGROUND OF THE INVENTION

In geographic climates that support the growth of deciduous trees, a common annual task of land and homeowners is to pick up leaves from the lawns and the surface of ground in the autumn after the leaves have been shed by surrounding trees. Unless the leaves are removed in a timely fashion they will slowly begin to decompose and can present a haven for moulds, insects and rodents. Furthermore, leaves that are strewn across a lawn and not removed are generally unsightly and can cause damage to the lawn if left for an excessive period of time.

Traditionally leaves and other debris have been collected by means of raking into piles for removal, or in some cases incineration. More recently, others have developed less labour intensive machines that may be used to vacuum leaves from the ground surface and deposit them into bags or other containers so that they may be disposed of or composted. Still others have proposed the use of high powered blowers that move and accumulate leaves. Machines have also been developed that mulch leaves into fine pieces so that they may be more readily broken down and absorbed into the soil.

Unfortunately, none of these prior methods of disposing of leaves and similar debris have met with complete success. Raking tends to be a labour intensive and physically demanding task. While vacuuming leaves into large bags or containers can be effective, the costs associated with the necessary equipment are in many cases prohibitive. Leaf blowers are also relatively expensive and generate excessive noise, to the extent that their use is restricted in some locations. Mulching leaves in-situ can add significantly to the level of thatch within a lawn which in some cases can have a debilitating effect. Finally, much of the equipment that has been developed to replace the need for raking is powered by gasoline engines that can be both costly to operate and environmentally damaging.

### SUMMARY OF THE INVENTION

The invention therefore provides an apparatus that can be used to assist in the collection of leaves and other debris distributed over a relatively large area, such as a lawn. The apparatus presents an effective mechanism to aid in the collection of debris and is relatively inexpensive, non-polluting, and is generally less labourious than traditional raking.

Accordingly, in one of its aspects the invention provides an apparatus to assist in the collection of debris distributed over a surface area, the apparatus comprising a hopper having a bottom surface with at least one generally flat ground engaging portion and having a leading edge and a trailing edge, said trailing edge offset from said leading edge and at an angle thereto, said hopper including a rear surface connected to said trailing edge, said bottom and said rear surfaces generally defining a partial enclosure which is tapered from a first end of said hopper to a second end of said hopper such that the cross-sectional area of said hopper increases in a direction from said second end to said first end; and, a handle secured to said hopper, said handle adapted to facilitate movement of said hopper along said surface area with said bottom surface generally contacting said surface area such that said leading edge is forced into contact with debris distributed over said surface area and said debris is directed into said partial enclosure.

In another aspect the invention provides an apparatus to assist in the collection of debris distributed over the ground or other surface area, the apparatus comprising a base portion having an upper surface and a bottom surface that has at least one generally flat ground engaging portion, said base portion having a leading edge and a trailing edge; and, a retainer to releasably secure said base portion to the blade of a shovel or scoop, said shovel or scoop having secured thereto a handle such that forward momentum applied to said handle causes said blade of said shovel or scoop to drive said base portion over the ground or other surface area with said generally flat ground engaging portion of said base contacting the ground or other surface area such that said leading edge is forced into contact with debris that is distributed over the ground or other surface area with said debris being collected and accumulated by said base portion and said blade of said shovel or scoop.

In a further aspect of the invention there is provided an apparatus to assist in the collection, accumulation and removal of leaves and other debris distributed over a lawn or the surface of the ground, the apparatus comprising an elongate sleeve releasably securable to the leading edge of the blade of a shovel or scoop, said sleeve including a plurality of outwardly disposed fingers such that when said sleeve is releasably received over the leading edge of the blade of a shovel or a scoop forward movement of the shovel or scoop over a lawn or the surface of the ground causes said fingers to contact the ground surface and urge leaves or other debris in the path of the shovel or scoop to be lifted upwardly from their position in contact with the surface of the ground such that the leaves or other debris collect and accumulate in front of the blade of the shovel or scoop.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is an upper front perspective view of an apparatus constructed in accordance with a preferred embodiment of the present invention;

FIG. 2 is a side elevational view of the apparatus of FIG. 1, shown as it may be used to collect leaves distributed over the surface of the ground;

FIG. 3 is an upper plan view of the apparatus shown in FIG. 1;

FIG. 4 is a partial upper side perspective view of an alternate embodiment of the apparatus shown in FIG. 1;

FIG. 5 is a sectional view taken along the line 5-5 of FIG. 4;

FIG. 6A is a sectional view taken along the line 6-6 of FIG. 4;

FIG. 6B is a sectional view similar to that of FIG. 6A, but of an alternate embodiment of the invention shown therein;

FIG. 7 is an upper front perspective view of an alternate embodiment of an apparatus constructed in accordance with the present invention;

FIG. 8 is a side view of the apparatus shown in FIG. 7; and,

FIG. 9 is an upper side perspective view of a third embodiment of an apparatus constructed in accordance with the present invention; and,

FIG. 10 is an end view of the apparatus shown in FIG. 9.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

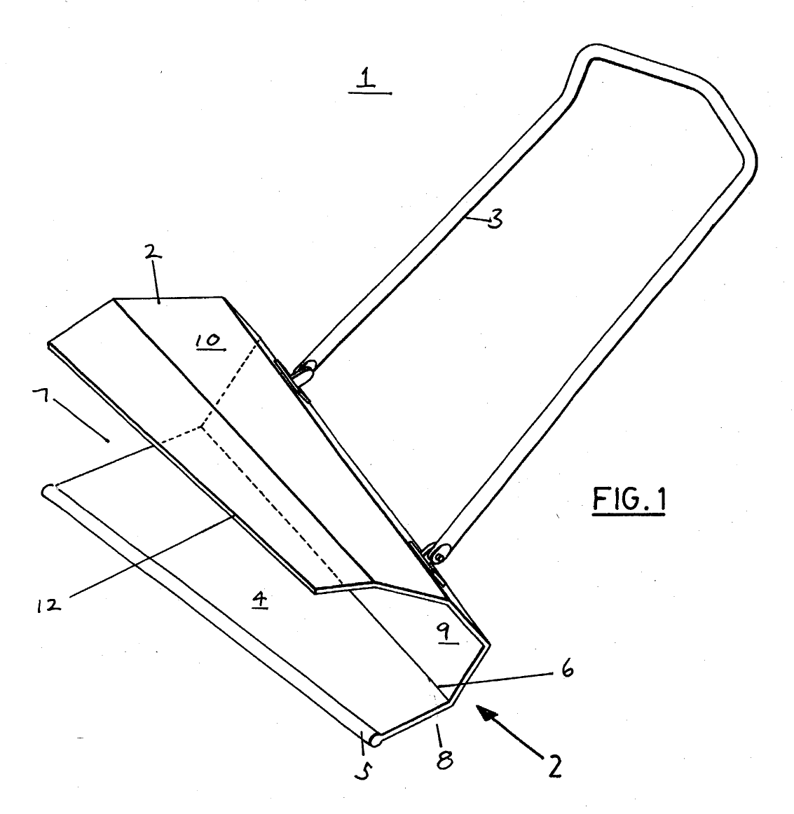

The apparatus constructed in accordance with a preferred embodiment of the present invention is generally identified in the attached drawings by reference numeral 1. Apparatus 1 is comprised primarily of a hopper 2 and a handle 3. As shown in FIG. 1, hopper 2 includes a bottom surface 4 with a leading edge 5 and a trailing edge 6. Trailing edge 6 is off-set from leading edge 5, and at an angle thereto, such that the leading and trailing edges are convergent in one direction and divergent in the opposite direction. Accordingly, the width of bottom surface 4 is greater at a first end 7 of hopper 2 than at a second end 8 of the hopper. In the embodiment shown in the attached drawings bottom surface 4 is of a generally flat and planar configuration. However, it will be appreciated by those of skill in the art that a variety of other configurations that include at least one generally flat ground engaging portion may also be utilized. For example, bottom surface 4 may be in the form of a wedge or may be a curved surface with one or more generally flat runners situated thereon.

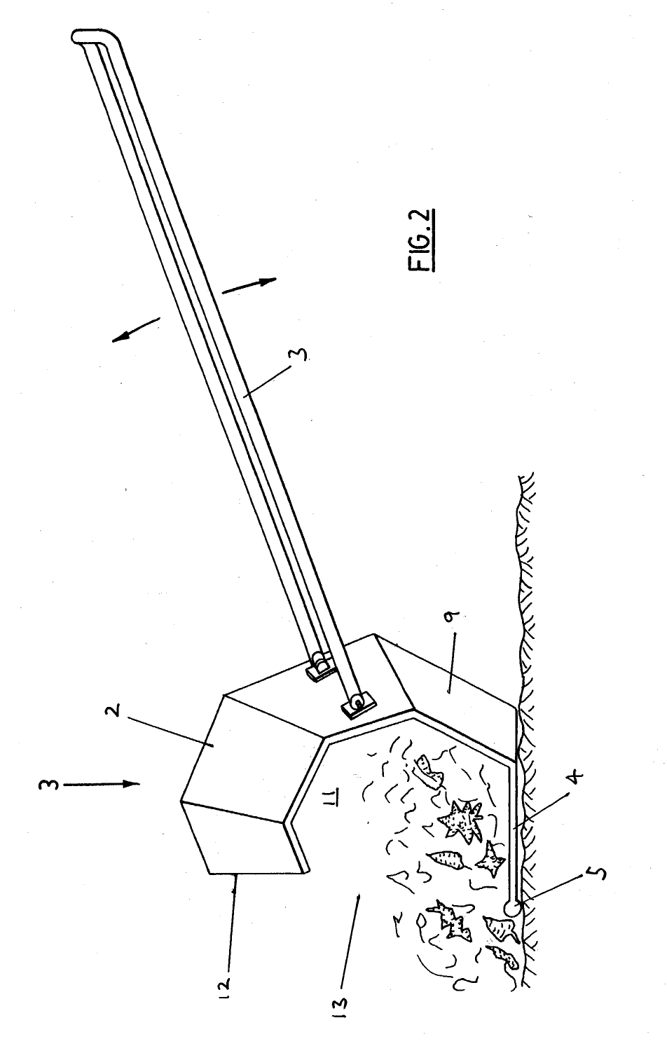

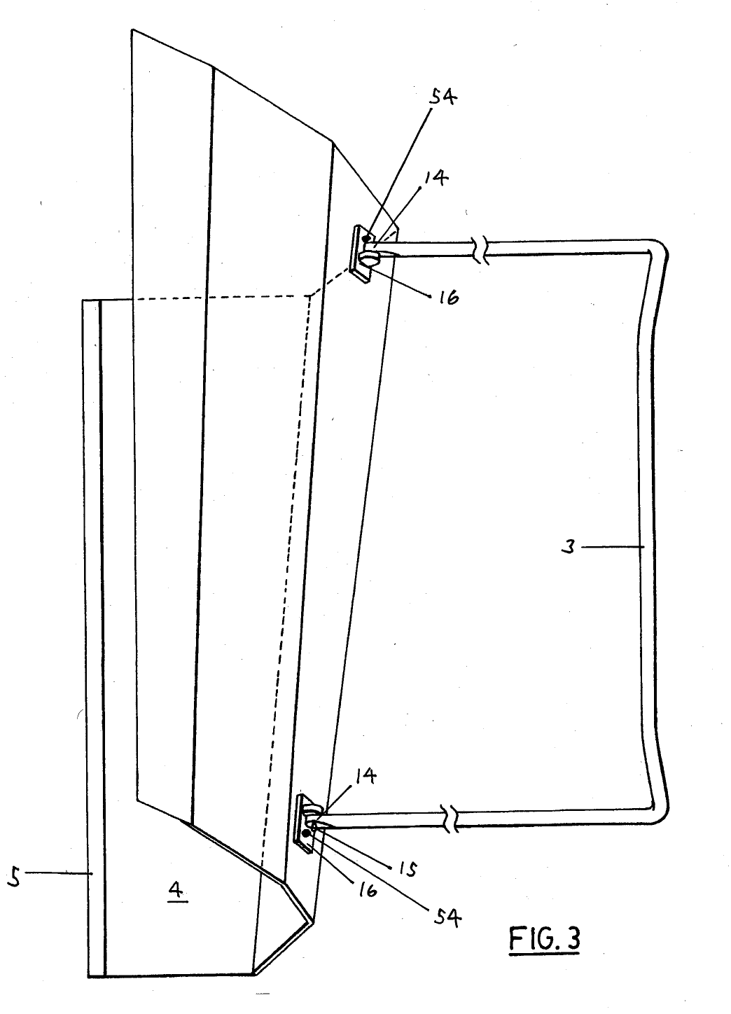

Hopper 2 further includes a rear or back surface 9 connected to trailing edge 6 such that the bottom and rear surfaces together form a partial enclosure 11 (see FIG. 2). In an alternate embodiment the hopper may also include an upper or top surface 10 connected to rear surface 9. Where a top surface is present partial enclosure 11 will be defined by the bottom, rear and top surfaces. The outer or frontal edge 12 of top surface 10 is vertically displaced from leading edge 5 presenting partial enclosure 11 with an open mouth portion 13 that is defined generally by leading edge 5 and frontal edge 12. As shown in FIG. 2, when constructed in this fashion hopper 2 will have a generally “C”-shaped cross-sectional appearance.

Through an appreciation of the construction of hopper 2 and an examination of the embodiment of the hopper depicted in the enclosed drawings, it will be noted that partial enclosure 11 is tapered from first end 7 toward second end 8. As a result the cross-sectional area of the hopper decreases in a direction from first-end 7 toward second end 8 and increases in a direction from second end 8 to first end 7. The tapered nature of the hopper has the effect of providing it with an overall funnel-like shape.

In one preferred embodiment of the invention handle 3 is secured to hopper 2 such that force applied to the handle in a direction that is generally parallel to the ground will cause the hopper to move in a forward direction with bottom surface 4 generally maintained in contact with the ground. In this manner as the hopper is pushed forwardly over the ground (or other surface area) leading edge 5 will be forced into contact with leaves or other debris that may be distributed over the ground, such that the leaves or debris will be directed into partial enclosure 11. The divergence of leading edge 5 and trailing edge 6, in conjunction with the general overall funnel-like shape of the hopper, will have the tendency to cause the leaves or debris that are directed into partial enclosure 11 to move through the hopper in a direction toward first end 7. This movement of debris into partial enclosure 11 and through hopper 2 is accomplished while leading edge 5 remains in a position that it is generally perpendicular to the direction of movement of the hopper. Leading edge 5 will therefore contact leaves or debris on the ground at an angle that is approximately 90 degrees to its direction of travel, which will in turn help to maximize the tendency for the leaves and debris to be driven into partial enclosure 11 and will also maximize the width of the path that is covered as apparatus 1 moves over the ground. Apparatus 1 thus presents an effective means to collect leaves or other debris that are lying upon the ground in the path of leading edge 5.

As the hopper fills with debris and is continuously pushed forward by means of handle 3, rear surface 9 will tend to deflect the debris toward first end 7 and eventually out of the hopper on to the ground adjacent to first end 7. Where the hopper has a generally “C” shaped cross-section, as the leaves and other debris within the hopper are pushed back into contact with rear surface 9 they will tend to be driven upwardly into top surface 10 and will roll over one another as they are deflected toward (and eventually discharged through) end 7. Movement of apparatus 1 over the ground or other surface will thus have the effect of collecting debris that may be present and depositing the debris in a row along first end 7. The row of debris will be generally parallel to the direction of movement of the hopper. Movement of apparatus 1 in a rectangular grid pattern will therefore result in the concentration of debris in a single row of material over a relatively small area, permitting the operator to more easily remove the debris for disposal. In this manner apparatus 1 enables an operator to quickly collect leaves and other debris that may be strewn over a large surface area in one or more rows for subsequent removal.

In an alternate mode of operation, hopper 2 is pushed along the surface of the ground until it is filled or partially filled with leaves or other debris. At that point the operator ceases pushing apparatus 1 and the open end of a trash bag is inserted over second end 8 of hopper 2. To empty the hopper the operator then need only to sweep his or her hand along the interior of enclosure 11 from first end 7 to second end 8. To assist in evacuating leaves and debris from the hopper, the operator may choose to tip hopper 2 such that rear surface 9 is in contact with the ground with the open mouth 13 of the hopper facing generally upwardly. In this orientation there will be a tendency for debris to remain within the hopper when it is swept into a trash bag received about second end 8. The funnel-like shape of the hopper facilitates directing leaves and other debris into the bag with minimal effort and spillage. Once the contents of the hopper have been evacuated, the bag can be removed from second end 8 and apparatus 1 can once again be pushed over the surface of the ground to continue to collect leaves and other debris. When hopper 2 becomes filled or partially filled the open end of the trash bag can be placed about second end 8 and the process repeated. In yet a further embodiment (not shown) second end 8 of hopper 2 may include hooks, clamps or other means for securing a bag thereabout such that the hopper may be lifted and used to funnel and deposit leaves or other debris directly into the bag.

It will also be appreciated by those having skill in the art that maintaining bottom surface 4 generally in contact with the ground or other surface over which apparatus 1 is moved not only assists in the collection of debris strewn over the ground but will also help to allow the apparatus to move smoothly over the ground, particularly where the ground is not perfectly flat. That is, maintaining bottom 4 of hopper 2 in contact with the ground will distribute the weight of apparatus 1 over a relatively large portion of the hopper and will allow the hopper to freely glide over bumps or other irregularities. In addition, by maintaining bottom surface 4 in contact with the ground, leading edge 5 will be maintained at a minimum angle of attack relative to the ground, thereby helping to prevent the leading edge of the hopper from digging into the ground. To further assist in allowing the hopper to float freely over the ground leading edge 5 is preferably blunt or rounded. In the embodiment shown in the attached drawings leading edge 5 has a generally circular cross-sectional configuration.

Most shovels and other similar hand tools include a handle that is rigidly fixed to a tool head. Maintaining a rigid connection between the handle and the head is in most instances critical in order to allow torque to be applied to the tool's head. However, with a rigidly secured handle the angle of attack between the leading edge of the tool and the ground can vary dramatically depending upon the height of the individual and the manner in which the handle is grasped and held. In a preferred embodiment of the present invention handle 3 is pivotally attached to hopper 2 such that it can be rotated in a vertical plane. In this manner bottom surface 4 will remain in contact with the ground as the hopper is pushed thereover, regardless of the height of the individual and the manner in which the the handle is held. The angle of attack of leading edge 5 will also be maintained generally constant for all operators. Further, the pivotal connection between handle 3 and hopper 2 enables bottom surface 4 to more freely glide over irregular ground surfaces and surfaces that may contain inclines or declines.

A variety of different mechanical structures could be employed to pivotally secure handle 3 to hopper 2. In the attached Figures one such method is shown wherein the ends 14 of handle 3 are provided with holes for receiving over pins 15 secured to hopper 2 by means of a pair of lugs 16. The ends 14 of handle 3 may then be retained about pins 15 through a biasing force applied by the handle or, alternatively, through the use of cotter pins or other mechanical fasteners. Preferably lugs 16 are secured to hopper 2 through use of a fastener 54 such that they are able to pivot about the fastener. Fastener 54 may be comprised of a bolt, pin, rivet or similar structure that will enable the lugs to pivot or rotate in a plane generally parallel to the surface of the hopper to which they are secured. It will thus be appreciated that through enabling lugs 16 to pivot about fasteners 54, and through the pivotal connection of handle 3 to lugs 16, there will effectively be presented a universal joint between the handle and the hopper to allow the handle to be more easily lifted or lowered according to the needs of the operator. It will also be appreciated that a wide variety of other universal joints may be utilized while remaining within the broad scope of the invention.

In a further embodiment each lug 16 may be fitted with a pair of pins 15 that are received through a pair of holes in the ends of the handle. Such a structure permits an operator to place handle 3 about one of the pins on each lug (wherein the handle would be freely floating) or to place ends 14 about both pins on each lug to effectively prevent rotation of the handle relative to the hopper. Fixing the handle also allows an operator to maintain and/or increase the angle of attack of leading edge 5 in situations where leaves or debris are compressed tightly against the ground, or where the surface of the ground is not level.

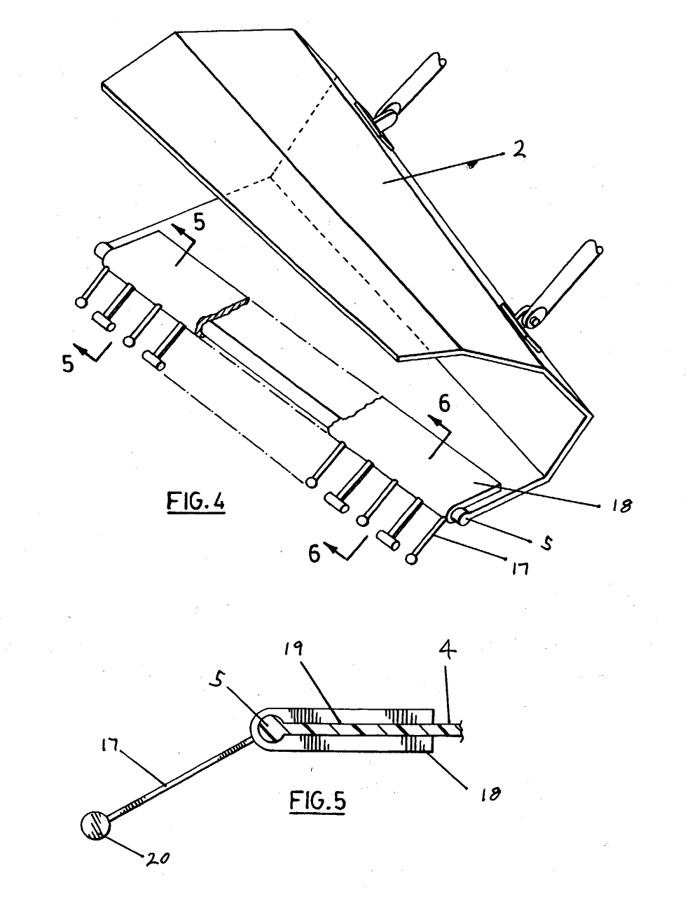

In the embodiments of the invention shown in FIGS. 4, 5, 6A and 6B leading edge 5 is fitted with a plurality of generally downwardly disposed fingers 17. Fingers 17 are preferably formed integrally or connected to a sleeve member 18 that may be releasably secured to leading edge 5. In these embodiments sleeve 18 has an internal cavity or slot 19 that permits it to be slid from either end of hopper 2 over leading edge 5. Accordingly, the sleeve and fingers may be easily and quickly added to or removed from hopper 2 as desired. When in place about leading edge 5 fingers 17 will be in contact with the ground or the surface area over which hopper 2 is moved.

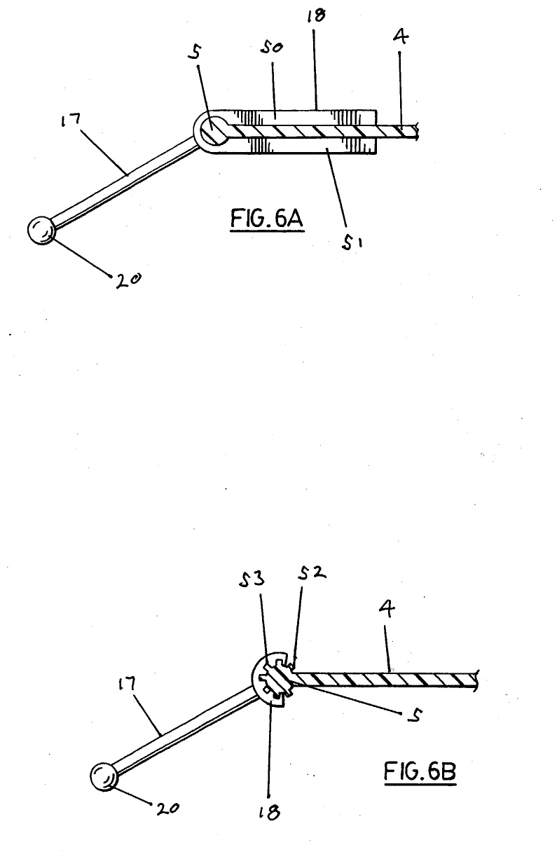

As indicated in FIG. 6A, sleeve member 18 may be rigidly secured to leading edge 5 through the use of upper and lower plates, 50 and 51 respectively, that contact opposite sides of the bottom surface of the hopper. Plates 50 and 51 are received snugly against the hopper bottom and result in the fixing of the angle of fingers 17 relative to the hopper. Alternately, and as shown in FIG. 6b, sleeve member 18 may be formed without plates 50 and 51 such that it is generally “C” shaped in cross section. In this case leading edge 5 preferably includes a series of longitudinal splines 52 for receipt within a series of longitudinal recesses 53 formed within sleeve 18. Such a splined connected between sleeve 18 and leading edge 5 will thus present an operator with the ability to adjust the angle of fingers 17 to optimally suit the conditions at hand. For example, when pushing hopper 2 over long grass it may be desirable to rotate sleeve 18 relative to leading edge 5 such that fingers 17 are fixed at a sharp angle. On the other hand, where the hopper is to be pushed over a hard ground surface it may be desirable to rotate the sleeve and reposition splines 52 within recesses 53 so that the fingers are more parallel to the bottom surface of the hopper.

As the hopper is pushed along the ground the fingers will have a tendency to gently scrape the ground surface and urge debris that is in the path of the hopper to be lifted upwardly and directed into partial enclosure 11. Preferably the ends 20 of fingers 17 are bulbous and/or cylindrical in configuration to help prevent them from penetrating the ground surface or becoming lodged therein. In addition, fingers 17 are preferably comprised of a plastic or metallic material that is flexibly resilient allowing them to gently scrape the ground surface while at the same time being able to ride over any surface irregularities that may be present. It is anticipated that operators of apparatus 1 will find the utilization of fingers 17 to be particularly useful when attempting to collect leaves or other debris that may be wet or that may have become matted down onto the surface of the ground. Where the debris of concern is not matted or lying tight to the ground surface, sleeve 18 and fingers 17 may be removed from hopper 2 and stored for future use.

Through an appreciation of the invention that has been described and shown in the attached drawings it will be understood that apparatus 1 presents a device that will enable an individual to easily, quickly, and with minimal physical effort collect and accumulate leaves and other debris distributed over the ground. While it is expected that a primary application of apparatus 1 will be for the collection of leaves on a lawn, the device will equally be effective for the collection of garbage and other debris that may be strewn across a playing field, an indoor or outdoor stadium floor, etc. The structure of apparatus 1 will also allow for the device to be constructed in a cost effective manner making the apparatus an economical alternative to other considerably more expensive machines that are currently in use. It is anticipated that hopper 2 will in many cases be formed from plastic or aluminum for ease of manufacture and to minimize costs. Bottom surface 4, rear surface 9 and upper surface 10 may be manufactured as a single unitary structure or may be formed separately to permit flat shipping. Where formed separately the component parts of the hopper can be created with interlocking channels along their edges, or utilize other mechanical means, to allow them to be easily assembled to form hopper 2. Furthermore, preferably at least a portion of the top and rear surfaces of the hopper are generally transparent so that an operator will have a clear view of both the interaction of leading edge 5 with the ground surface and the debris that is received within the hopper.

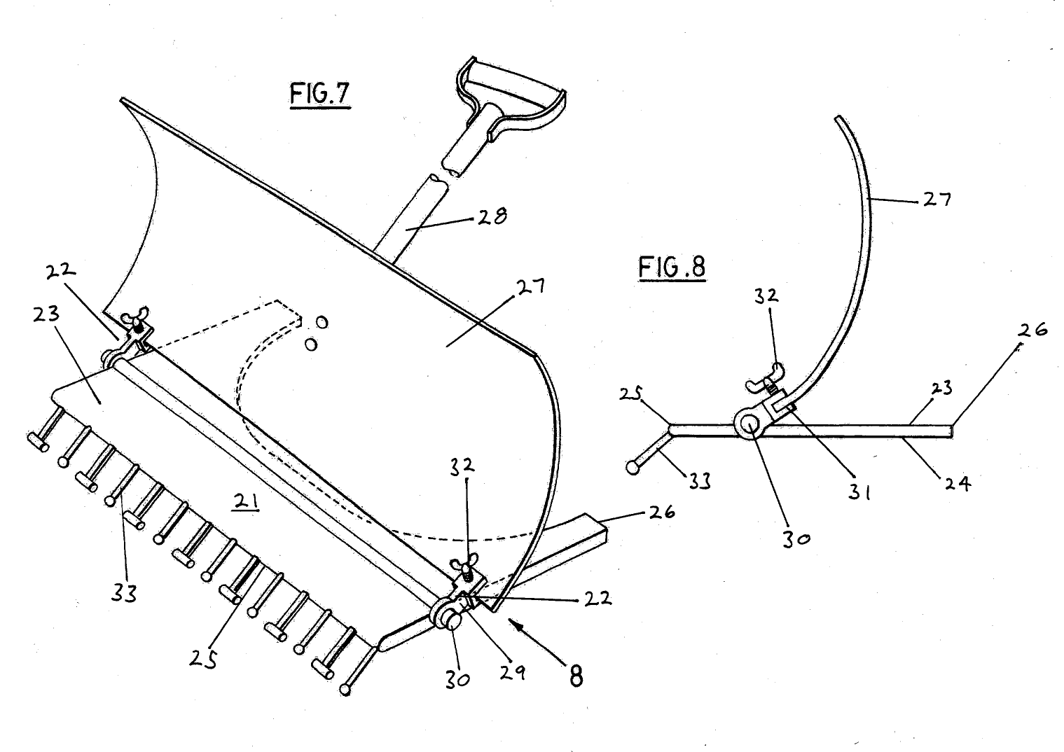

FIGS. 7 and 8 show an alternate embodiment of the invention wherein apparatus 1 is generally comprised of a base portion 21 and a retainer 22. Base portion 21 is preferably rectangular in shape, having an upper surface 23, a bottom surface 24, a leading edge 25 and trailing edge 26. Bottom surface 24 may be itself generally flat and planar in construction, or may be of an alternate configuration that has at least one generally flat ground engaging portion. If desired, to minimize material requirements and cost, the rear-most aspect of base portion 21 may include an arcuate, rectangular or other cut-out (shown in ghost outline in FIG. 7).

As indicated in FIGS. 7 and 8, retainer 22 releasably secures base portion 21 to the blade 27 of a shovel or scoop 28. The shovel or scoop 28 may be any one of a wide variety of such products that are commonly available. In the attached drawings, for illustration purposes a standard snow shovel has been shown.

It will be appreciated that a number of different types of retainers could be utilized to releasably secure blade 27 to base portion 21. In the embodiment depicted in the attached drawings retainer 22 comprises a pair of hinged fasteners 29, one of which is positioned at each end of base portion 21. Fasteners 29 may be constructed so as to pivot about pins 30 that are located on the sides or upper surface of base portion 21 in a manner such that the pins are generally parallel to leading edge 25. A slot 31 in the opposite end of each fastener 29 permits the leading edge of blade 27 to be received therein. A threaded bolt 32 may be inserted through the fastener and tightened to compress slot 31 and secure the base portion to the shovel blade. The end of the shovel will thus be releasably secured to apparatus 1 while still permitting limited rotational movement of the shovel relative to base portion 21. In a different embodiment of the invention fasteners 29 may releasably fix blade 27 to base 21 in a manner that prevents relative movement or rotation between the blade and the base.

Leading edge 25 of base portion 21 may be constructed so that it is blunt or rounded to enable the base to be more easily pushed over the surface of the ground. Alternatively, leading edge 25 may include a plurality of generally downwardly disposed fingers 33 that, as in the case of the previously described embodiments, contact the surface of the ground when the base portion is pushed forwardly. Fingers 33 may be formed directly upon the leading edge of the base portion or may be attached to a sleeve that is received over the leading edge of the base, as in the embodiments described above and as shown in FIGS. 6A and 6B. The fingers will help to assist in urging leaves and other debris to be lifted upwardly off the ground surface so that they may be collected and accumulated in front of the blade of the shovel. The distal ends of fingers 33 preferably are bulbous to help prevent the fingers from penetrating the ground surface.

Accordingly, the embodiment of apparatus 1 shown in FIGS. 7 and 8 presents a device that may be readily secured to the blade of a shovel or scoop, and that when attached thereto will assist in the collection of leaves and other debris by merely pushing the shovel forward over the surface of the ground. Forward momentum applied to the handle of the shovel will cause the shovel's blade to drive base portion 21 over the ground surface. Leading edge 25 and/or fingers 33 will then be forced into contact with debris that may be present on the ground causing the debris to be collected and accumulated both on the base portion and in front of the blade of the shovel.

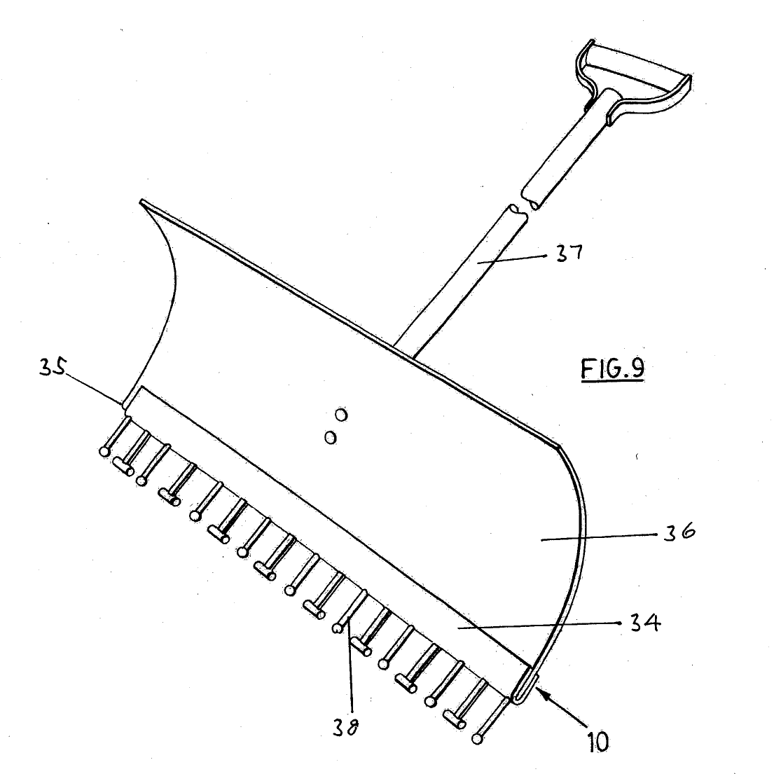

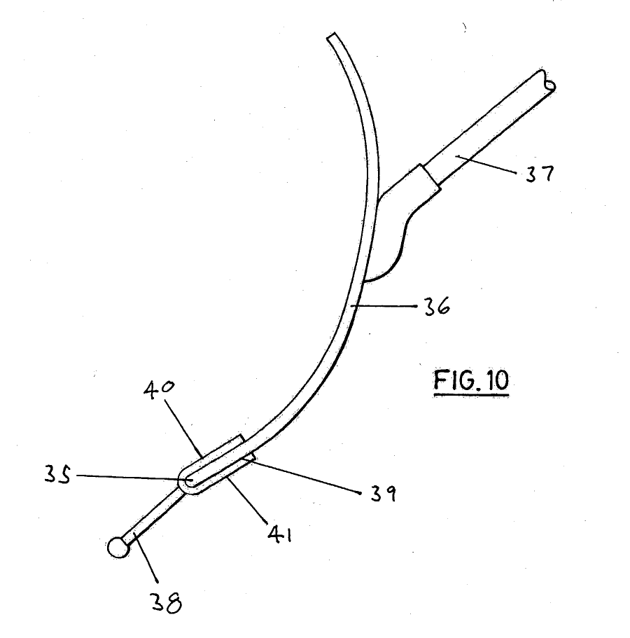

A further embodiment of the invention is depicted in FIGS. 9 and 10. Here apparatus 1 is comprised of an elongate sleeve 34 that is releasably securable to the leading edge 35 of the blade 36 of a shovel 37. Sleeve 34 includes a plurality of outwardly disposed fingers 38. A longitudinal slot 39 within sleeve 34 permits leading edge 35 of blade 36 to be inserted therein in order to secure the sleeve to the shovel. It is expected that in most instances the sleeve will be retained upon the leading edge of the shovel through frictional forces, however, if desired a screw, bolt, rivet or other fastener may be utilized to make the attachment of the sleeve semi-permanent.

This described structure presents a device that, through movement of the shovel over a lawn or the surface of the ground, will cause fingers 38 to contact the ground and assist in urging leaves or other debris in the path of the shovel to be lifted upwardly and into the path of the forwardly moving shovel. Once again, as in the previously described embodiments, the distal ends of FIG. 38 are preferably bulbous to help prevent the figures from penetrating the ground surface. In addition, sleeve 34 preferably includes an upper force distribution plate 40 and a lower force distribution plate 41 that contacts the upper and lower surfaces of shovel blade 36. Torsional forces that may be applied to sleeve 34 through contact of fingers 38 with the surface of the ground will be transferred to upper and lower plates 40 and 41 and borne by those plates, enhancing the rigidity and structural integrity of the device.

It is to be understood that what has been described are the preferred embodiments of the invention and that it may be possible to make variations to these embodiments while staying within the broad scope of the invention. Some of these variations have been discussed while others will be readily apparent to those skilled in the art.

We claim:

1. An apparatus to assist in the collection of debris distributed over a surface area, the apparatus comprising:
(i) a hopper having a bottom surface with at least one generally flat ground engaging portion and having a leading edge and a trailing edge, said trailing edge offset from said leading edge and at an angle thereto, said hopper including a rear surface connected to said trailing edge, said bottom and said rear surfaces generally defining a partial enclosure which is tapered from a first end of said hopper to a second end of said hopper such that the cross-sectional area of said hopper increases in a direction from said second end to said first end; and,
(ii) a handle secured to said hopper, said handle adapted to facilitate movement of said hopper along said surface area with said bottom surface generally contacting said surface area such that said leading edge is forced into contact with debris distributed over said surface area and said debris is directed into said partial enclosure.

2. An apparatus as claimed in claim 1 wherein said hopper includes a top surface connected to said rear surface such that said partial enclosure is defined by said bottom, rear and top surfaces, said top surface having an outer edge and said partial enclosure having an open mouth portion between said leading edge of said bottom surface and said outer edge of said top surface, said partial enclosure tapered from said first end of said hopper toward said second end of said hopper such that the cross-sectional area of said hopper increases from said second end to said first end.

3. An apparatus as claimed in claim 1 wherein said leading edge is blunt or rounded to assist in movement of said hopper along said surface area.

4. An apparatus as claimed in claim 1 wherein said leading edge is oriented generally perpendicular to the direction of travel of said hopper over said surface area.

5. An apparatus as claimed in claim 1 wherein said handle is pivotally attached to said hopper such that said handle can be rotated in a vertical plane allowing said bottom surface to generally remain in contact with said surface area as said hopper moves thereover.

6. The apparatus as claimed in claim 5 including means to releasably fix said handle in place and to prevent rotation of said handle relative to said hopper.

7. An apparatus as claimed in claim 1 wherein said leading edge includes a plurality of generally downwardly disposed fingers, said fingers contacting said surface area as said hopper is moved relative thereto and assisting in urging debris in the path of said hopper into said partial enclosure.

8. An apparatus as claimed in claim 7 wherein said fingers are connected to a sleeve which is releasably securable to said bottom surface of said hopper.

9. An apparatus as claimed in claim 8 wherein said fingers have bulbous distal ends to help prevent said fingers from penetrating said surface area.

10. An apparatus as claimed in claim 2 wherein at least a portion of said top and rear surfaces of said hopper are generally transparent.

11. An apparatus as claimed in claim 1 wherein said surface area is a lawn and said debris is comprised of fallen leaves.

12. An apparatus as claimed in claim 1 wherein said handle is secured to said hopper by means of a universal joint permitting limited pivotal and rotational movement of said handle relative to said hopper.

13. An apparatus to assist in the collection of debris distributed over the ground or other surface area, the apparatus comprising:
(i) a base portion having an upper surface and a bottom surface that has at least one generally flat ground engaging portion, said base portion having a leading edge and a trailing edge; and,
(ii) a retainer to releasably secure said base portion to the blade of a shovel or scoop, said shovel or scoop having secured thereto a handle such that forward momentum applied to said handle causes said blade of said shovel or scoop to drive said base portion over the ground or other surface area with said generally flat ground engaging portion of said base contacting the ground or other surface area such that said leading edge is forced into contact with debris that is distributed over the ground or other surface area with said debris being collected and accumulated by said base portion and said blade of said shovel or scoop.

14. The device as claimed in claim 13 wherein said retainer comprises at least one hinged fastener releasably securing said blade of said shovel or scoop to said base portion while permitting limited rotational movement of said blade relative to said base portion.

15. The device as claimed in claim 13 including means to prevent rotation of said blade of said shovel or scoop relative to said base portion

16. The device as claimed in claim 13 wherein said leading edge of said base portion is blunt or rounded.

17. The device as claimed in claim 13 wherein said leading edge of said base portion includes a plurality of generally downwardly disposed fingers, said fingers contacting the ground or other surface area as said base portion is moved relative thereto and assisting in urging debris in the path of said base portion to be collected and accumulate in front of said blade of said shovel or scoop.

18. The device as claimed in claim 13 including a plurality of generally downwardly disposed fingers, said fingers positioned upon a sleeve member releasably received about said leading edge of said base portion and contacting the ground as said base portion is pushed forwardly thereby assisting in urging debris in the path of said base portion to be collected and accumulate in front of said blade of said shovel or scoop.

19. The device as claimed in claim 17 wherein said fingers have bulbous distal ends to help prevent said fingers from penetrating the ground or other surface area.

20. An apparatus to assist in the collection, accumulation and removal of leaves and other debris distributed over a lawn or the surface of the ground, the apparatus comprising an elongate sleeve releasably securable to the leading edge of the blade of a shovel or scoop, said sleeve including a plurality of outwardly disposed fingers such that when said sleeve is releasably received over the leading edge of the blade of a shovel or a scoop forward movement of the shovel or scoop over a lawn or the surface of the ground causes said fingers to contact the ground surface and urge leaves or other debris in the path of the shovel or scoop to be lifted upwardly from their position in contact with the surface of the ground such that the leaves or other debris collect and accumulate in front of the blade of the shovel or scoop.

21. The apparatus as claimed in claim 20 wherein said fingers have bulbous distal ends to help prevent said fingers from penetrating the ground surface.

22. The apparatus as claimed in claim 20 wherein said sleeve includes an upper force distribution plate contacting the upper surface of the blade of the shovel or scoop and a lower force distribution plate contacting the lower surface of the shovel or scoop such that torsional forces applied to said sleeve through the contact of said fingers with the surface of the ground are borne by said upper and lower force distribution plates.
